(19) United States
(12) Patent Application Publication
(10) Pub. No.: US 2010/0116609 A1
(43) Pub. Date: May 13, 2010

(54) SHOCK ABSORBERS

(76) Inventor: Steffen Schewerda, Aschaffenburg (DE)

Correspondence Address: PRICE HENEVELD COOPER DEWITT & LITTON, LLP, 695 KENMOOR, S.E., P O BOX 2567, GRAND RAPIDS, MI, 49501, US

(21) Appl. No.: 12/531,883

(22) PCT Filed: Feb. 19, 2008
(86) PCT No.: PCT/EP08/01280

§ 371 Date: Sep. 18, 2009

(30) Foreign Application Priority Data
Mar. 23, 2007 (DE) 102007014124.8

(51) Int. Cl. F16F 9/54

(52) U.S. Cl. 188/321.11

(57) ABSTRACT

Shock absorbers or suspension dampers, particularly for motor vehicles, including a first and a second section that can move relative to one another, wherein the first and second sections each have a first or second fastening section at the distal end region, a first fastening element is provided at the first fastening section, and a second fastening element is provided at the second fastening section, and wherein the fastening elements are constructed differently and/or are disposed differently from one another with respect to the longitudinal axis of the shock absorber.

### BACKGROUND OF THE INVENTION

The present invention relates to a shock absorber, especially for motor vehicles, which is designed to dampen the impacts and vibrations acting on an axle system of the motor vehicle.

Shock absorbers are rather well known from the prior art. Thus, shock absorbers exist that are designed from a cylinder and a piston led through this cylinder, with mounting lugs being provided at the distal end regions of the cylinder and piston to secure the shock absorber to a frame element, as well as an axle element of the vehicle that can move relative to this. However, there also exist shock absorber layouts in which the shock absorber is arranged on an incline. Regardless of the layout of the shock absorber, the danger exists that the shock absorber will be mounted in the wrong installation position, leading to failure of the shock absorber. Thus, a shock absorber whose upper mounting lug is mounted at the bottom and whose lower mounting lug is mounted at the top (i.e., twisted about its axis) will not work properly. Furthermore, there are shock absorbers whose rotational position is likewise fixed, so that a twisting of the shock absorber through 180 degrees about the lengthwise axis would result in an improper functioning.

Therefore, the problem of the present invention is to provide a shock absorber, especially for motor vehicles, that ensures a correct position of installation in the motor vehicle.

### SUMMARY OF THE INVENTION

According to the invention, a shock or vibration absorber is provided, especially for motor vehicles, comprising a first and second section able to move relative to each other, wherein the first and second section each have a first and second fastening section at the distal end region, and wherein a first fastening element is provided at the first fastening section and a second fastening element at the second fastening section, being different in configuration and/or arranged differently in relation to the lengthwise axis of the shock absorber. The first and second sections are nested such that the first and second section can move relative to each other in a preferably linear or translatory direction along the lengthwise axis of the shock absorber or parallel to it. The free or distal end regions of the first and second section each have a fastening section. Each of the fastening sections has a fastening element to fasten the first and second section to a frame element or to the axle element of the vehicle which can move relative to the former. The first fastening element fashioned on the first fastening section and the second fastening element fashioned on the second fastening section are different in configuration. In other words, the first and second fastening element can differ from each other in their geometrical dimensions. Thus, the first fastening element can have a geometrical inner and/or outer configuration which differs from that of the second fastening element, so that the fastening means for the first fastening element cannot engage with the second fastening element. In addition or alternatively, the first fastening element and the second fastening element can be arranged or positioned differently in relation to the lengthwise axis of the shock absorber. This also ensures that the fastening means for the first fastening element cannot engage with the second fastening element if the shock absorber is not properly installed. Thus, a shock absorber or vibration absorber is provided in which a twisted installation position is prevented during its mounting, since the first fastening element differs from the second such that they can only be fastened by their respective fastening means to the vehicle, and cannot be mounted or engage with each other if installed wrong.

In the illustrated examples, the first fastening element is arranged basically central to the lengthwise axis of the shock absorber. The lengthwise axis of the shock absorber basically corresponds to the direction of movement of the first and second section relative to each other, or it is parallel to this. Thus, in other words, the first fastening element is arranged symmetrically to the lengthwise axis of the shock absorber so that the first fastening element extends in a transverse direction by essentially the same amount, starting from the lengthwise axis of the shock absorber, in the opposite direction. The middle or axis of symmetry of the first fastening element thus essentially corresponds to or is aligned with the lengthwise axis of the shock absorber.

As further illustrated, preferably the second fastening element is arranged essentially off-center to the lengthwise axis of the shock absorber or not symmetrical to the lengthwise axis of the shock absorber. In other words, the free ends of the second fastening element are arranged at different distances in relation to the lengthwise axis of the shock absorber. Thus, the center or axis of symmetry of the second fastening element and the lengthwise axis of the shock absorber are advantageously spaced apart. This means that the second fastening element is arranged essentially asymmetrically to the lengthwise axis of the shock absorber, so that a twisting or rotation of the shock absorber by 180 degrees about the lengthwise axis of the shock absorber has the result that the second fastening element can no longer be brought into engagement with the fastening means provided on the vehicle. Consequently, the installer becomes aware of the wrong position of installation.

As also illustrated, the second fastening element is fashioned wider than the first fastening element. In other words, the dimension of the second fastening element in a transverse direction of the shock absorber is larger than that of the first fastening element. The transverse direction of the shock absorber is essentially perpendicular or orthogonal to the lengthwise axis of the shock absorber. Thanks to the different width dimensions of the first and second fastening elements, an incorrect position of installation of the shock absorber in which the first fastening section is arranged at the fastening means of the vehicle provided for the second fastening section is indicated to the installer by no engagement or no proper engagement being possible between the respective fastening element and the corresponding fastening means or point of the vehicle frame.

In another embodiment, the first and second sections comprise a cylinder and a piston led through the latter. Advantageously, a piston rod is arranged on the piston, in order to move the piston in the cylinder, preferably filled with oil. Upon axial movement of the piston rod or the cylinder, the oil is moved through valve openings or flow channels in the piston, and the resistance to flow and thus the dampening action increases with the speed of movement of the piston.

In one illustrated embodiment, at least one valve is arranged in the cylinder near the bottom, having valve openings preferably arranged asymmetrically. The shock absorber is thus preferably designed as a two-pipe shock absorber. This design has one working cylinder and a container pipe arranged basically coaxially with the latter, defining two spaces: the working space within the working cylinder, in which the piston and the piston rod move, and the annular oil reservoir space between working cylinder and container pipe, serving to balance out the changes in oil volume in the working space caused by the movements of the piston rod, while working space and oil reservoir space are separated from each other by the valve located near the bottom. The term “near the bottom” should be taken to mean here, in particular, relative to the nominal position of installation of the shock absorber, that the valve is located in the lower region of the shock absorber. The asymmetrical arrangement of the valve openings or flow channels is especially advantageous for an inclined position of installation of the shock absorber. The valve openings in this case are in particular advantageously arranged in a circular segment of the valve, which points downward or defines the lowest point of the valve. This ensures that oil can flow through the valve openings even when the shock absorber is installed in a very slanted or nearly horizontal position.

As illustrated, the first section comprises the piston and the second section the cylinder. Of course, the second section can likewise be defined by the piston and the first section by the cylinder.

Preferably, the first and second fastening elements are fashioned as a cylinder, especially a hollow cylinder. The fastening elements in this case can have any desired cross sectional shape, and especially advantageously they are designed as a bushing or tube, in order to engage by means of coordinated fastening means, such as screws or bolts.

Preferably, the first and/or second fastening elements are mounted elastically or able to restore their position in the first or second fastening section. The first and second fastening section define especially advisedly a bushing or a tube, in which the first and second fastening elements are arranged basically concentrically or coaxially so that a rubber sheath or sleeve or a rubber bearing is arranged between the fastening element and the fastening section.

Further benefits and features will emerge from the following description of a preferred embodiment of the invention with regard to the enclosed drawings.

### BRIEF DESCRIPTION OF THE DRAWINGS

FIG. 1 is a cross-sectional side view of an embodiment of the invented shock absorber;

FIG. 2 is a top view of one embodiment of the invented shock absorber in the installed condition; and

FIG. 3 is an enlarged cross-sectional partial side view of the shock absorber.

### DETAILED DESCRIPTION OF THE PREFERRED EMBODIMENTS

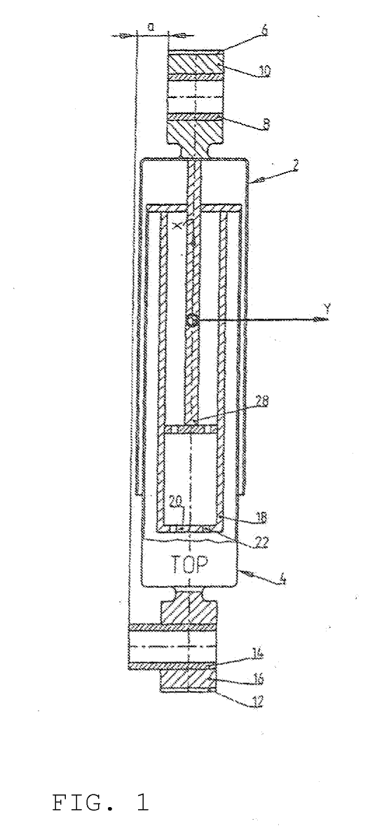

FIG. 1 shows a preferred embodiment of the invented shock and vibration absorber in cross section. The shock absorber has a first section 2 and a second section 4, which are preferably able to move or be displaced relative to each other along a lengthwise axis x of the shock absorber.

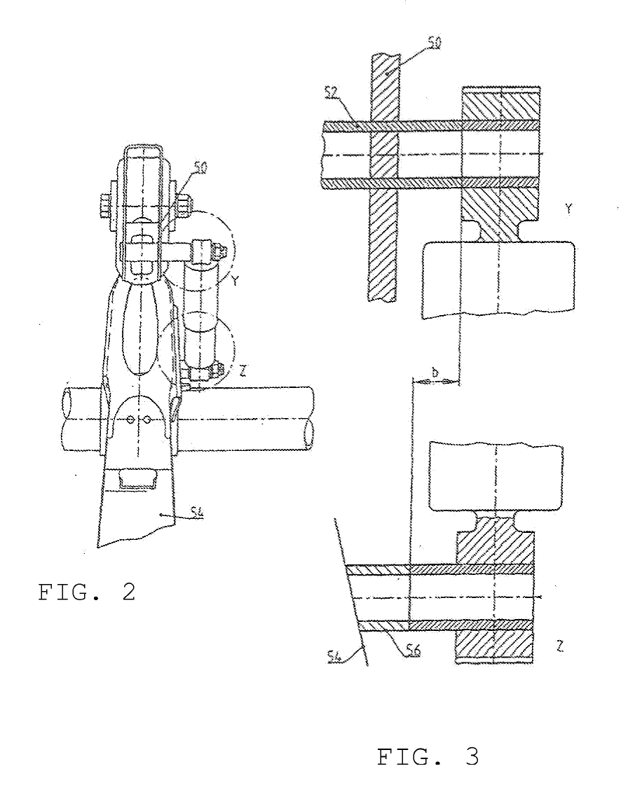

The first section 2 has at its distal end region a first fastening section 6. The first fastening section 6 is configured as a lug or tube, so as to take up a first fastening element 8 essentially concentrically therein. The first fastening element 8 is taken up or fastened in the first fastening section 6 by an elastic rubber bearing 10. The rubber bearing 10 serves to compensate for small relative movements between the first section 2 and a frame element of the vehicle on which it is fastened (see FIG. 2). The fastening occurs by a screw or a bolt, which passes through the sleeve or tube-shaped first fastening element 8 and is fastened on the frame element.

Basically opposite to the first section 2, the second section 4 has at its distal end region a second fastening section 12. The second fastening section 12 is configured as a tubular fastening lug—in keeping with the first fastening section 6. For the fastening of the second section 4 to a part of the vehicle axle, a second fastening element 14 is fastened by a rubber bearing 16 essentially concentrically or coaxially in the second fastening element 12. The rubber bearing 16, like the rubber bearing 10, serves to compensate for small offset movements between the second fastening section 12 and the second fastening element 14, which is connected by appropriate fastening means, such as screws or bolts, to the vehicle axle element.

The first fastening element 8 is arranged basically centrally or symmetrically to the lengthwise axis x of the shock absorber, whereas the second fastening element 14 is arranged basically off-center or asymmetrically to the lengthwise axis x of the shock absorber. Accordingly, the lengthwise axis x of the shock absorber basically intersects the center of the first fastening element 8, whereas the center of the second fastening element 14 is at a distance from the lengthwise axis x of the shock absorber (at a distance to the left in the depicted embodiment). Advantageously, the second fastening element 14 is wider than the first fastening element 8, i.e., the second fastening element 14 has a dimension in the transverse direction y which is larger than the dimension of the first fastening element 8 in the transverse direction y. The transverse direction y in this case is arranged basically perpendicular or orthogonal to the lengthwise axis x of the shock absorber. In a configuration of the first fastening element 8 and/or second fastening element 14 as a cylinder or a hollow cylinder, the transverse direction y is basically parallel to the axis of rotation of the first fastening element 8 and/or second fastening element 14. Due to the geometrically different configuration and/or different arrangement of the first fastening element 8 and second fastening element 14 in relation to the lengthwise axis x of the shock absorber, there is thus provided a shock absorber or vibration absorber whose position of installation is predetermined or fixed. In particular, a mounting of the shock absorber of the invention twisted through 180 degrees about the lengthwise axis or a mounting of the shock absorber of the invention (especially a shock absorber with bottom valve 20 pointing downwards), in which the first fastening section 6 is fastened to the position intended for the second fastening section 12, is not possible.

Of course, the first fastening element 8 and/or the second fastening element 14 can also be configured as bolts having any desired cross section. The cross section in this case is preferably round or circular. However, it can also be polygonal, in particular, hexagonal or octagonal.

This is especially advantageous when the shock absorber is configured as a two-pipe shock absorber. Here, a valve 20 is provided near the bottom of the cylinder 18 in the cylinder 18 of the second section 4. The valve 20 has preferably asymmetrically arranged valve openings 22. The valve openings 22 serve in particular to let through the shock absorber oil from a working space 24 in an annular oil reservoir space 26, in order to equalize the changes in oil volume in the working space 24 caused by the movements of the piston 28 of the first section 2. If the shock absorber has a horizontal or greatly inclined arrangement, it is especially advantageous to arrange the valve openings 22 asymmetrically so that they lie as low as possible, in order to assure a continuous flow of oil.

FIG. 2 shows one embodiment of the invented shock and vibration absorber in the installed state. The first fastening section 6 here is designed to be fastened on a frame element 50 of the vehicle. The fastening occurs on tubular fastening means 52, which, together with the first fastening element 8, can have a bolt or a screw passing through them. The fastening of the second fastening section 12 occurs accordingly on an axle element 54 of the vehicle that can move relative to the frame element 50, likewise having tubular fastening means 56 which, together with the second fastening element 14, can have a bolt or a screw passing through them.

As can be seen in FIG. 1, the fastening planes of the first fastening element 8 and the second fastening element 14, being essentially parallel to the lengthwise axis x of the shock absorber, are spaced apart by the distance a. The distance a corresponds here to the distance b between the fastening planes of the fastening means 52 and 56. Therefore, the shock absorber of the invention can be mounted—as long as the asymmetrical bottom valve 20 is supposed to point downward—in only one predetermined position, since a twisting or swiveling of the shock absorber would result in the fastening means 52 no longer making contact with the first fastening element 8 and/or the fastening means 56 no longer making contact or being engaged with the second fastening element 14. Consequently, the predetermined installation position is clearly recognizable to the installer.

Especially favorably, the first fastening element 8 and/or the second fastening element 14 have a contact surface for making contact with the fastening means 52 or the fastening means 56. If the first fastening element 8 or the second fastening element 14 has a tubular or cylindrical or boltlike or hollow cylinder shape, the contact surfaces are those end faces turned toward the fastening means 52 of the frame element 50 or the fastening means 56 of the axle element 54. The contact surfaces are preferably planar or level, and their plane of contact is essentially flush with the lengthwise axis x of the shock absorber. In other words, the plane of the contact surface is essentially perpendicular to the transverse axis y of the shock absorber or to the lengthwise axis of the first and second fastening element 8, 14, configured as a cylinder or hollow cylinder or bolt. The contact surface of the first fastening element 8 or second fastening element 14 can, however, alternatively also be inclined to the lengthwise axis x of the shock absorber, so that the plane of the contact surface is not perpendicular to the transverse axis y of the shock absorber or the lengthwise axis of the first and second fastening elements 8, 14. Of course, the contact surface can additionally or alternatively have a nonlevel surface configuration, for example, in the form of a toothing, knurling, or fluting, in order to afford an optimized engagement with the corresponding part of the vehicle.

1-9. (canceled)

10. A shock absorber, comprising:
a first and second section able to move relative to each other, wherein the first and second sections each have a first and second fastening section at a distal end region, and wherein a first fastening element is provided at the first fastening section and a second fastening element is provided at the second fastening section and is different in configuration and arranged differently in relation to a lengthwise axis of the shock absorber from the first fastening section, wherein the first and second fastening element are fashioned as a cylinder each have a lengthwise axis that is directed transversely to the lengthwise axis of the shock absorber.

11. The shock absorber according to claim 10, wherein the first fastening element is arranged substantially central to the lengthwise axis of the shock absorber.

12. The shock absorber according to claim 11, wherein the second fastening element is arranged substantially off-center to the lengthwise axis of the shock absorber.

13. The shock absorber according to claim 12, wherein the second fastening element is wider than the first fastening element.

14. The shock absorber according to claim 13, wherein the first and second sections comprise a cylinder and a piston extending through the cylinder.

15. The shock absorber according to claim 14, wherein a valve is arranged in the cylinder near a bottom of the cylinder, having valve openings arranged asymmetrically.

16. The shock absorber according to one of claim 14 or 15, wherein the first section comprises the piston and the second section comprises the cylinder.

17. The shock absorber according to claim 15, wherein at least a select one of the first and second fastening elements includes a hollow cylinder.

18. The shock absorber according to claim 16, wherein at least a select one of the first and second fastening elements is mounted elastically in the first and second fastening section respectively.

19. The shock absorber according to claim 10, wherein the second fastening element is arranged substantially off-center to the lengthwise axis of the shock absorber.

20. The shock absorber according to claim 10, wherein the first and second sections comprise a cylinder and a piston extending through the cylinder.

21. The shock absorber according to claim 10, wherein a valve is arranged in the cylinder near a bottom of the cylinder, having valve openings arranged asymmetrically.

22. The shock absorber according to one of claim 20 or 21, wherein the first section comprises the piston and the second section comprises the cylinder.

23. The shock absorber according to claim 10, wherein at least a select one of the first and second fastening elements includes a hollow cylinder.

24. The shock absorber according to claim 10, wherein at least a select one of the first and second fastening elements is mounted elastically in the first and second fastening section respectively.
